(19) United States
(12) Patent Application Publication
(10) Pub. No.: US 2006/0169905 A1
(43) Pub. Date: Aug. 3, 2006

(54) Fissile material detector having an array of active pixel sensors

(76) Inventor: John S. Wenstrand, Menlo Park, CA (US)

Correspondence Address: AVAGO TECHNOLOGIES, LTD., P.O. BOX 1920, DENVER, CO, 80201-1920, US

(21) Appl. No.: 11/048,990

(22) Filed: Feb. 1, 2005

(51) Int. Cl. G01T 1/24

(52) U.S. Cl. 250/370.1

(57) ABSTRACT

A system and method detecting fissile material. According to one embodiment, a detector includes an array of active pixel sensors wherein each active pixel sensor operable to integrate a charge generated by radiation that is incident upon the active pixel sensor by using a charge-sensing element during an integration phase. Then, a voltage signal is generated that is based upon the integrated charge intensity during a readout phase. After reading out the voltage signal during the readout phase, the active pixel sensor is reset ready to integrate again. The integration phase is typically set to a time interval that is optimal for detecting radiation from fissile material, and the system is typically able to count individual events occurring in an integration period, and to digitally sum these event counts to measure rate of radiation events.

### BACKGROUND OF THE INVENTION

The proliferation of nuclear weapons is a threat to national and world security and the threat continues to be ever-increasing as the interest and capability of rogue nations and factions in attaining fissile material used to produce nuclear weapons increases. Detecting fissile material at major arteries of transportation, such as airports and train stations, is an important front in preventing the proliferation of fissile material that may be used in weapons systems or even as a weapon in and of itself. As a result, governments and private security agencies have used fissile material detection systems capable of detecting a number of different kinds of fissile material to alert security agents to the presence of possible nuclear threats.

One particular type of detection system utilizes a neutron sensor in the form of a Complementary Metal Oxide Semiconductor (CMOS) array or a Charge-Coupled Device (CCD) array of pixels having a special coating. The coating is able to react when radiation is incident thereupon to produce a charge which is then detected at one or more pixels in the array. Typically, the charge generated by this reaction provides more than enough energy to invoke a maximum charge deposition in the pixels nearest the reaction. As a result, when fissile material that is actively emitting neutrons is very near the neutron sensor, the pixel array is able to immediately detect any emitted neutrons that strike near one or more pixels.

The coating, either disposed on the array or on a cover plate near the array, is typically enriched boron, commonly referred to as B¹⁰, such that when a neutron strikes the coating, the nucleus of the B¹⁰ reacts with the neutron to produce approximately a 1.47 MeV alpha particle. A typical pixel is easily able to detect this alpha particle and, as is often the case, several pixels around the most adjacent pixel are also able to detect this alpha particle. As such, the coating is typically referred to as conversion material because it converts energy from a neutron emitted from fissile material to an alpha particle capable of being detected by a pixel in a CMOS or CCD array. Other types of conversion material have been used in the past to detect different kinds of fissile material, such as lithium and other isotopes of boron. Further, different types of conversions using different conversion materials may be implemented to detect gamma rays as well, such as a gold foil coating on a phosphor layer.

FIG. 1 is a schematic diagram showing one implementation of a conventional three-transistor active pixel sensor 100 which is used to digitize one pixel of charge. When used to capture an image, the number of pixels in an active pixel sensor 100 array determines the resolution of the captured image. When used herein, for the purposes of detecting fissile material, the number of pixels is simply of function of the size of the detector and may be virtually any size. Furthermore, the size of the pixels, themselves, may be manufactured to be virtually any size.

A typical active pixel sensor 100 pixel includes three transistors 120, 121, and 122, and a charge-sensing element 125 disposed in a silicon area on top of which are disposed multiple metal layers. Five terminal traces for pixel control include RESET 110, PRESET 111, V_{dd} 112, COLUMN 113, and ROW 114. Each active pixel sensor 100 also includes a GROUND 115 terminal. By using a controller (not shown) to control the signals at each of the control terminals for the active pixel sensor 100, in conjunction with all other contacts associated with other active pixel sensors 100 (not shown) in a CMOS array, charge intensity striking the CMOS array, i.e., an alpha particle, may be detected and digitized. The nature of this detection and digitization is described below with respect to the timing diagram of FIG. 2.

FIG. 2 is a timing diagram of the conventional operation of the active pixel sensor 100 of FIG. 1. The operation of the active pixel sensor 100 includes a reset phase 200, an integration phase 220, and a readout phase 240. Each of these phases 200, 220, and 240 is described below with respect to the timing diagram.

Before detection, each active pixel sensor 100 must first be “cleared” during the reset phase 200. This is to make sure that all the pixels in the array (not shown) have the same starting voltage when the charge-sensing element 125 begins integrating charge. During time period 201, the active pixel sensor 100 is in a previous readout phase 240 and, thus (as is explained below with respect to the readout phase 240), the RESET 110 trace is set to a predetermined low voltage level (typically 0 volts) and the ROW 113 and PRESET 111 traces are set to a predetermined high voltage level (typically 2.5-5.0 volts). At t2, the RESET 110 trace is raised to a high voltage level so that the transistor 121 acts as a closed switch. As such, the voltage at node 130 is equal to the voltage at the PRESET 111 trace. The voltage at node 130 may turn on transistor 122, but any current that may flow through transistor 122 is inconsequential because any resultant signal on the COLUMN 113 trace will not be sensed until the readout phase 240 as described below. Next, the PRESET 111 trace is dropped to a predetermined low voltage level while the RESET 110 trace remains at the high voltage level. Thus, the voltage at node 130 becomes low which causes the parasitic capacitance (not shown) associated with the charge-sensing element 125 to be discharged. Finally, the PRESET 111 trace is brought back to the high voltage level to charge the parasitic capacitance of the charge-sensing element 125 to a predetermined starting voltage level to complete the reset phase 200.

Next, during the integration phase 220, after the charge-sensing element 125 is reset, the RESET 110 trace is set to a low voltage so that the transistor 121 turns off at t3. Now, the charge-sensing element 125 is ready for exposure to charge that may be generated from incident radiation. During predetermined time period 204, the charge-sensing element 125 is exposed to charge. As is known, the charge-sensing element 125, which may be a photodiode, for example, draws a reverse current that is proportional to the intensity of the charge that is striking it, and thus, partially or fully discharges the parasitic capacitance.

After the predetermined integration time period 204, the readout phase 240 begins. The ROW 114 trace is brought to a high voltage level at t5 such that the transistor 120 becomes a closed switch and transistor 122 acts as a source follower. This results in the voltage at node 130, which represents the charge intensity detected during the integration phase 220, biasing the voltage on the COLUMN 113 trace to this voltage level minus the V_{GS} drop from the transistor 122. The COLUMN 113 trace is coupled to a constant current source (not shown) such that the voltage at node 130 will translate to a corresponding voltage on the COLUMN 113 trace via transistor 122. Since the voltage threshold of the transistor 122 is or is approximately the same for all transistors 122 in other active pixel sensors 100, the effects of the V_{GS} drops cancel out such that processing circuitry (not shown) determines the intensity of the charge at the pixel captured by the active pixel sensor 100 based on the voltage on the COLUMN 113 trace.

Each phase described above is repeated for each row of active pixel sensors 100 in a array during a data capture cycle. Each row is cycled separately and typically done so in a rolling fashion. That is, when the first row transitions from the reset phase to the integration phase the next row begins the reset phase. Therefore, no row of pixels is ever being read while another row of pixels is being read. In this manner, a detector having an array of pixels is able to monitor for the incidence of radiation emitted from fissile material.

FIG. 3 is a conventional detector having a conventional pixel array 301 that is capable of detecting radiation that may strike one or more pixels. The pixel array 301 comprises a vast number of pixels, all of which are arranged into rows and columns. As can be seen, radiation in the form of an energy particle, such as a neutron 305, that may have been emitted from fissile material may strike the pixel array 301. In some cases, the neutron 305 may strike the pixel array 301 on a path that is normal to the array 301. As a result, typically only one or a small number of individual pixels are activated when the neutron 305 is detected. However, if the neutron 305 approaches the pixel array 301 from an extreme angle, as depicted in FIG. 3, several adjacent pixels in a row may be activated as the glancing path of the neutron 305 is detected in a long, drawn-out pattern. A long, drawn-out pattern, often called a bloom pattern 310, is interpreted by the detector 300 as a large number of neutrons resulting in an erroneous indication that fissile material is imminently close to the detector 300 when, in fact, an anomalous neutron 305 may have struck the pixel array 301. This is problematic as false positives lead to less reliance on the accuracy of the detector 300.

Several additional problems exist with conventional detectors, such as detector 300 of FIG. 3. For one, a conventional active pixel sensor 100 is designed to have an integration time long enough to detect an ambient level of light during an image capture operation. However, if used for fissile material detection, when radiation (alpha particles, neutrons, or gamma rays, for example) strikes any conversion material, the resultant generated charge is more than intense enough to immediately maximize the level of charge at the charge-sensing element. Thus, the remainder of the integration period is superfluous since the detecting of the generated charge has already occurred and any additional charge detection may not occur at the already fully-charged pixels.

Furthermore, a phenomenon known as dark current may be problematic when trying to detect infrequent events. Dark current is the thermally induced current that exists in a charge-sensing element in the absence of incident charge or light. Several detectors 300 have problems with dark current (also referred to as leakage current) when integration times are long. This results in a charge build-up in each active pixel sensor 100 even if there is no charge or light incident on the charge-sensing elements 125. Dark current is exponentially dependent on the temperature, and is halved for approximately every 7° C. drop in temperature. The dark current adds to the voltage signal and has negative consequences. Because it varies with temperature, it can cause baseline (background) change over the time which contributes to the overall noise. For some common types of sensors at room temperature, dark current becomes especially problematic during longer integration periods, i.e., integration periods beyond 100 ms.

Yet another problem associated with fissile material detectors of the past is the ability to only detect a single kind of radiation. For example, in order to detect neutrons emitted from plutonium, enriched boron is well-suited for reacting with emitted plutonium neutrons to produce charge that can be detected at active pixel sensors. However, enriched boron is poorly suited for reacting to gamma rays as is the case with lithium or other conversion materials. Thus, the detector 300 is only useful for detecting a single kind of radiation.

Other problems associated with conventional active pixel arrays 301 used in conventional detectors 300 and methods used therewith are prevalent when used for the detection of fissile material will become apparent in the detailed description of the present invention, below.

### SUMMARY OF THE INVENTION

An embodiment of the invention is directed to a detector for detecting fissile material. The detector includes an array of active pixel sensors wherein each active pixel sensor operable to integrate a charge generated by radiation that is incident upon the active pixel sensor by using a charge-sensing element during an integration phase. Then, a voltage signal is generated that is based upon the integrated charge intensity during a readout phase. After reading out the voltage signal during the readout phase, the active pixel sensor is reset ready to integrate again. The integration phase is typically set to a time interval that is optimal for detecting radiation from fissile material. That is, the integration time is relatively short so as to avoid problems associated with dark current noise but not too short such that the detector cycles through the readout and reset phases too often which leads to inefficient use of power.

The array further includes a coating disposed adjacent to the array. The coating is a conversion material operable to convert an incident radiation into a charge that may be detected by at least one of the active pixel sensors. Common conversion materials include Boron, Lithium, and gold foil.

Such an array in a detector is useful for detecting fissile material that may be proximate. As the integration times become larger, the duty cycle approaches 100% which is desirable for detection. Further, the coating material may be two or three different kinds of material in order to detect different kinds of emissions from different kinds of fissile material. Still further, the detector may be light weight, hand-held and power efficient so as be portable and inexpensive.

Thus, a traveler in the streets of a busy city benefits from having a light-weight, portable unit that still affords some detection capabilities of nearby fissile material. Additionally, an employee at a facility that may have incident radiation, such as a hospital or dental office, also benefits from being able to detect the presence of radiation.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of showing one implementation of a conventional three-transistor active pixel sensor;

FIG. 2 is a timing diagram of the conventional operation of the active pixel sensor of FIG. 1;

FIG. 3 is a conventional neutron detector having a conventional pixel array that is capable of detecting neutrons that are incident upon one or more pixels;

FIG. 4 is a block diagram of a fissile material detector according to an embodiment of the invention;

FIG. 5 is an isometric view of stacked arrays that may be included in the detector of FIG. 4 according to an embodiment of the invention;

FIG. 6 is an isometric view of arrays arranged in a cube that may be included in the detector of FIG. 4 according to an embodiment of the invention;

FIG. 7 shows a rotating cover plate mechanism that may be used in conjunction with the array described in FIG. 4 according to an embodiment of the invention;

FIG. 8 shows an array having a coating of different conversion materials that form a mosaic pattern on the array according to an embodiment of the invention; and

FIG. 9 is a block diagram of a handheld detector having some of the elements of the detector of FIG. 4 according to an embodiment of the invention.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

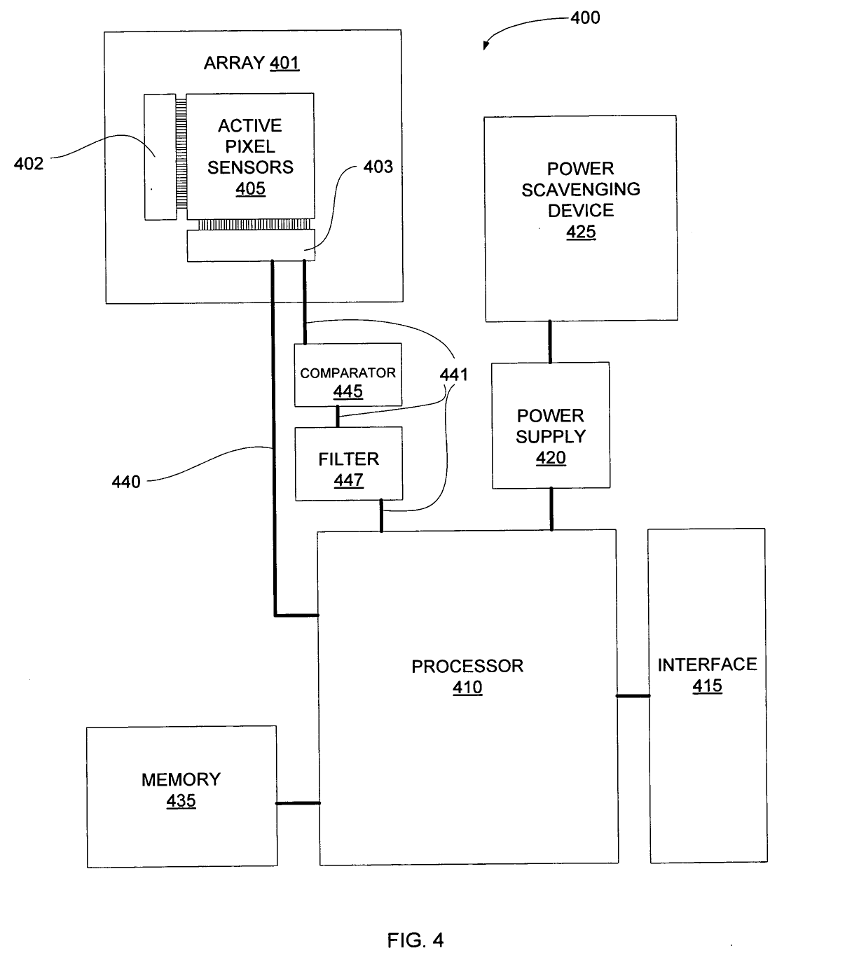

FIG. 4 is a block diagram of a fissile material detector 400 according to an embodiment of the invention. The detector 400 includes an array 401 of active pixel sensors 405 (not shown in detail) arranged in rows and columns. In a typical embodiment, the array includes 1024 rows and 1024 columns of active pixel sensors 405 covering an actual area of about one square centimeter. As a general rule, smaller and more numerous active pixel sensors 405 in an array 401 will result in better manufacturing yield as small manufacturing defects on a few sensors 405 out of many will not affect the ability for the array 401 to properly function. Having larger and less numerous active pixel sensors 405 may lead to other inefficiencies such as a larger pixel capacitance that might make it difficult to detect a single event, and a larger capture cross-section which will increase the likelihood of detection of multiple events for an given integration period thus convolving dose and energy. Hence, a typical size for an active pixel sensor 405 in an array 401 is about 10 to 200 um.

Each row is electrically connected to row select circuitry 402 and each column is electrically connected to column select circuitry 403. Other known circuit blocks (not shown), such as data multiplexors and buffers, assist in the manipulation and handling of all captured data signals in the active pixel sensors 405, but are not detailed herein for clarity. Using this row and column configuration, each of the active pixel sensors 405 in the array 401 may be isolated, accessed, integrated, and reset via the control options through the row select circuitry 402 and the column select circuitry 403.

The row select circuitry 402 and the column select circuitry 403, i.e., the array 401 may be controlled by a processor 410 coupled to the array 400. The array 401 is coupled to a processor in two ways. First, the processor 410 is able to control the array 401 during a data capture cycle through a control line 440. Second, the processor 410 is able to receive data captured by the array 401 through a data line 441. The control line 440 and the data line 441 are described in more detail below with respect to particular aspects of the invention.

The processor 410 is able to control the array 401 in a number of ways including initiating a data capture cycle. A data capture cycle typically includes three phases in order to utilize the active pixel sensors 405 most efficiently. Thus, according to one embodiment, each of the active pixel sensors 405 in the array 401 is operable to integrate charge intensity of a particle that may be incident upon any of the active pixel sensors 405 by using a charge-sensing element during an integration phase, store an electrical signal based upon the integrated charge intensity during a readout phase, and reset the charge-sensing element during a reset phase. These three phases constitute one data capture cycle.

Typically, each row of the array 401 undergoes a data capture cycle separately. For example, each active pixel sensor 405 in a first row starts the data capture cycle, i.e., reset phase, integration phase, and readout phase described above with respect to FIG. 2, prior to another row starting the same data capture cycle. During the readout phase, the voltage on the COLUMN trace (not shown in FIG. 4) at each active pixel sensor 405 in the first row may be read by the row control circuitry 403 and column control circuitry 403 according to known methods such that a voltage signal from every pixel may be read and sent to the processor 410 via the data line 441. The signal may be multiplexed for serial transmission or may be sent in parallel on a per-column basis. The processor 410 then facilitates the manipulation of signals received on the data line 441 to store and analyze all voltage signals captured during data capture cycles.

Alternatively, a data capture cycle may be designed to simply detect that an event has occurred and ignore the particular pixel that has detected fissile material. That is, in the above example, using both row control circuitry 402 and column control circuitry 403, each voltage signal for each active pixel sensor 405 may be captured and manipulated separately. Thus, through multiplexing and de-multiplexing the signals on the COLUMN trace of each active pixel sensor 405, each voltage signal may be isolated and later identified in an analysis procedure at the processor 410. Such isolation is necessary for image capture, however, when using an array 401 for fissile material detection, isolating between pixels is not necessary since the goal of the array 401 is simply to detect an event. Thus, in other embodiments, the column control circuitry 403 and/or row control circuitry 402 may not be needed for simple detection methods that only read each column or the array as whole.

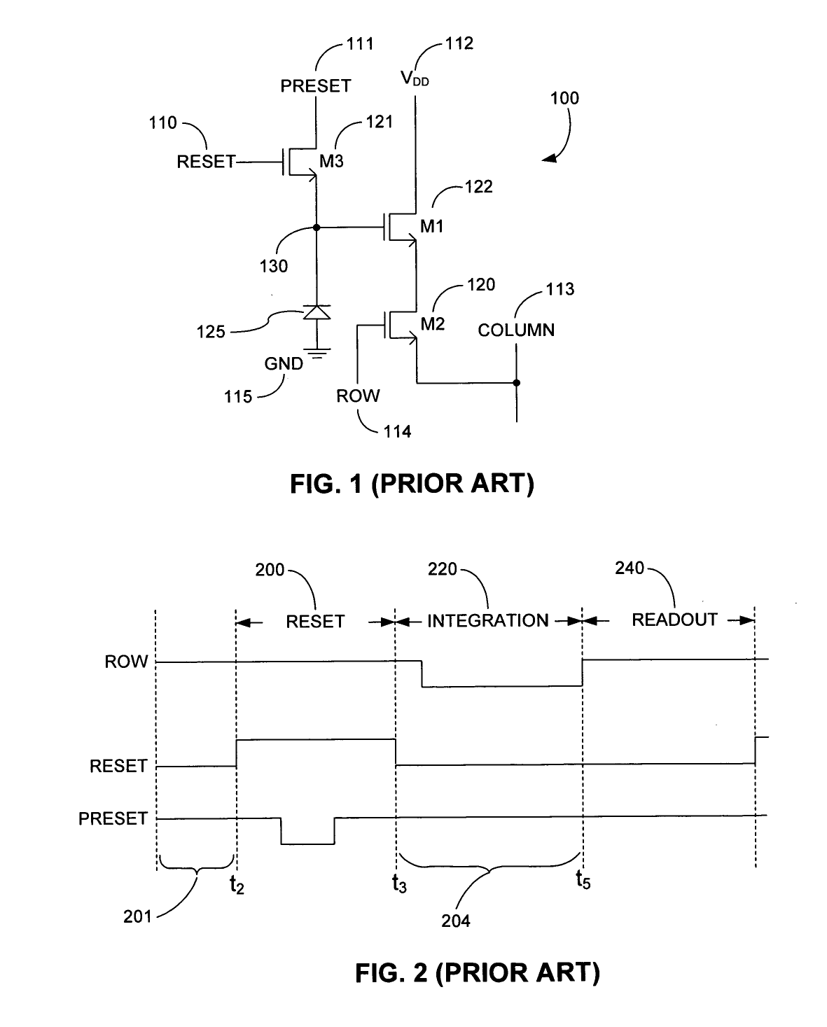

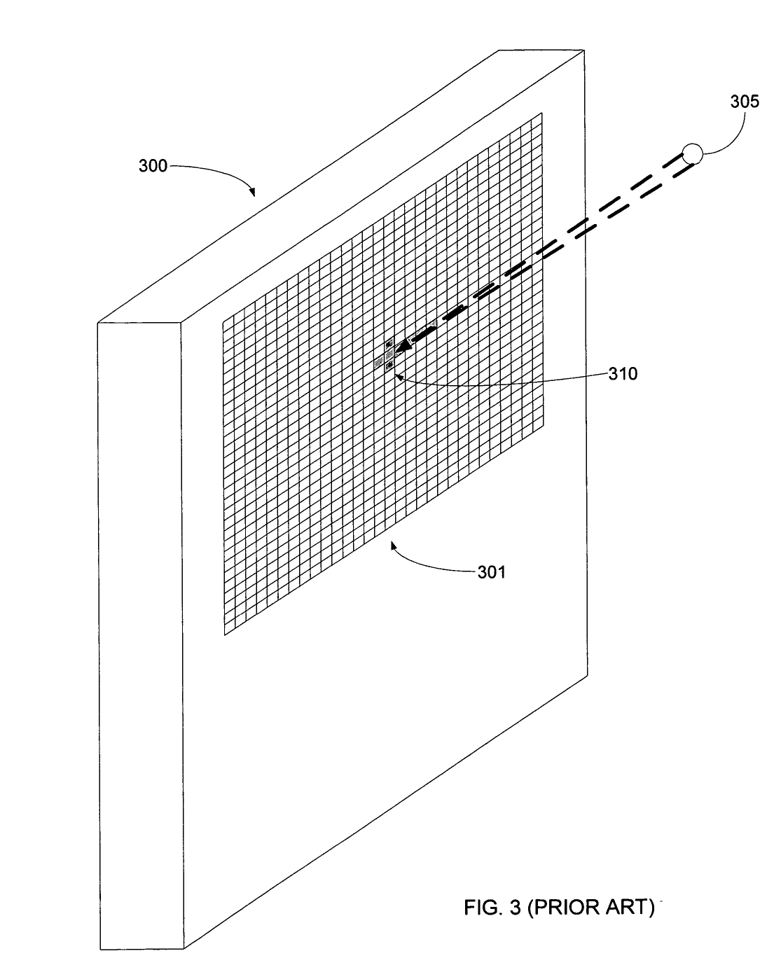

For example, an array 401 of active pixel sensors may be designed to have only two transistors (transistor M3 121 and transistor M1 122 of FIG. 1, for example) such that a row select transistor (transistor M2 120) becomes unnecessary by coupling the output of each active pixel sensor 405 in each respective row together. Thus, when any one of the active pixel sensors 405 in a given row detects an event, the single connection to the row detects a generated voltage signal. Of course, there would be no way to distinguish which active pixel sensor 405 in the row generated the voltage signal, but this may not be necessary if the goal of the array 401 is only detection as opposed to measurement of radiation intensity.

Furthermore, the same concept may be applied to the elimination of the column control circuitry 403 as well. As a result, if any active pixel sensor 405 in the entire array 401 detects an event, the generated voltage signal will constitute the entire signal on the data line with no way to determine even which row the event was generated. Thus, the circuitry becomes even more simplified at the expense of not being able to garner intensity of radiation information.

Simplified circuitry allows for a closer approximation to a 100% duty cycle. A 100% duty cycle, i.e., the detector is always “detecting”, provides the best chance for event detection. Further, each active pixel sensor 405 may be designed to be a self-resetting active pixel sensor. That is, once an event is detected and read out on the data line 441, the particular active pixel sensors (or more) that detected the event may be individually reset. Thus, all other non-event active pixel sensors need not cycle through a reset and readout phase unnecessarily. As a result, all other active pixel sensors 405 may still be detecting while one or, at most, a handful of sensors 405 are being read out and reset.

As was described in the background of the invention, fissile material, such as some isotopes of uranium and plutonium, are unstable such that neutrons are emitted from some of the atoms in the fissile material. This is known as radiation and can be detected. Of course, if enough neutrons are emitted from fissile material in a tightly controlled environment, a nuclear reaction is achieved if critical mass is accomplished, i.e., enough neutrons being emitted to initiate a chain reaction of additional neutrons being emitted from adjacent atoms of the fissile material.

It is known that neutrons emitted from fissile material will interact with some materials, in particular enriched boron, such that alpha particles are produced during a nuclear reaction. Typically, an alpha particle will deposit about 0.05 pCoul of charge in a silicon substrate coated with enriched boron, or about 300,000 electrons. Thus, when a typical neutron is incident upon a substrate having an array 401 of active pixel sensors 401 which is coated with enriched boron (boron coating not shown for clarity), more than enough charge is generated to be captured by one or more charge-sensing elements in one or more active pixel sensors 405. Other kinds of fissile material may emit gamma rays which may also be detected using different types of conversion material. As used herein, the term radiation includes at least thermal neutrons, alpha particles, or gamma rays. Thus, the array 401 of the detector 400 is typically coated with a material that is able to produce charge when one or more kinds of radiation emitted from fissile material is incident thereupon.

For example, fissile material may be close enough to the detector 400 such that neutrons emitted from the fissile material come incident upon the array 401. During a data capture cycle, the charge generated by the neutrons striking the enriched boron coating will cause the deposition of charge in the charge-sensing device of adjacent active pixel sensors 405 to fairly high levels, and likely to the maximum level. The charge is converted to a voltage signal at the particular active pixel sensor 405 nearest the point that the neutron struck the enriched boron (or several active pixel sensors 405 in the case of a bloom pattern). During a readout phase, the voltage signal is read by the column control circuitry 403 and eventually transmitted as part of a digital data signal to the processor 410 on the data line 441. The processor 410 may then indicate that fissile material has been detected during the last data capture cycle by activating an alarm or the like.

Using an array 401 to detect fissile material is different than using an array 401 to capture an image. When an array 400 is used for the capture of an image, such as when used in a camera system, the integration phase for each of the active pixel sensors 405 is typically long enough to capture enough light to adequately charge a charge-sensing element for image capture. However, when an array 401 is used as a fissile material detector, the total integration time may be much longer and in some cases on the order of minutes since it is desirable that the detector should always be “detecting”. This is especially so since some detectable events are nearly equivalent to background radiation levels and occur infrequently. Therefore, dark current becomes problematic over the course of longer integration periods such that the charge buildup at each of the active pixel sensors 405 causes noise in the data signal transmitted to the processor during the readout phase.

As a result, the detector 400 of FIG. 4 may utilize many short integration phases of about 1/15 to 1/30 of a second. Many consecutive short integration times alleviates the problem of dark current as the charge-sensing element is reset during each reset phase. Furthermore, since a typical radiation event that may be detected at the array 401 is so intense and sudden shorter integration times are typically long enough to still detect the charge generated at the conversion material that is adjacent to one or more active pixel sensors 405. In this manner, each data capture cycle can be transmitted to the processor 410 and the data may be analyzed as collected for suspected events.

Further, because a single particle desired to be detected generates enough of a reaction when it is incident upon the array 401, a simple 1-bit analysis is sufficient in handling the data captured. That is, when using an array 401 to capture charge intensity for a different purpose, such as image capture in a camera, it is beneficial to be able to measure the intensity of charge to a high degree of accuracy, i.e., the intensity is expressed as a number ranging from 0 to 255 (8 bits) or from 0 to 65535 (16 bits). In this application however, an event (a particle striking the array 401) will generate a large intensity almost instantaneously. Thus, a 1-bit comparator 445 may be used in lieu of more complicated 8- or 16-bit system. As such, having the comparator 445 in the data line 441, the detector 400 is able to indicate the incidence of radiation if the voltage signal generated from the detection of the radiation simply exceeds a predetermined threshold.

Although the comparator 445 is shown in FIG. 4 as a distinct block in the block diagram, the comparator 445, may in fact, be an entire block of 1-bit comparators associated with the row control circuitry 402 and the column control circuitry 403. As such, the voltage signals generated at each of the active pixel sensors 405 need only be compared to a single threshold to determine whether an event has occurred (a conversion to data bit 1) or has not occurred (a conversion to data bit 0). Manipulating and transmitting data expressed in one bit is significantly faster and easier than dealing with 8- or 16-bit data. For this method of event detection to be most effective, the integration period should be selected such that the likelihood of two events occurring in a single pixel in a single integration period is low, as the one-bit comparator recognizes the presence of an event, but not the number of them.

As data is collected by the processor 410, it may be stored and archived in a memory 435. The data can be analyzed in real time for event occurrences, anomalies, or data trends by the processor 410. One such analysis that is particularly useful in fissile material detection is analyzing the pixel pattern of events, or the so-called bloom pattern. As was discussed above, when radiation is incident upon an array 401, it may cause two or more adjacent active pixel sensors 405 (adjacent by row or by column) to indicate the presence of charge. However, this should only be counted as a single incidence of one neutron even though more than one of the active pixel sensors 405 detected it. The processor 410 may be programmed to recognize bloom patterns and consider some occurrences of multiple events as a single event. In this manner, the detector 400 will correctly identify a single radiation event despite several active pixel sensors 405 detecting the charge during a single data capture cycle. Thus, if fissile material is truly in close proximity, the next data capture cycle will likely detect one or more additional radiation events which, then, may be correctly interpreted as a positive detection instead of an anomaly.

Furthermore, since there will typically be many consecutive data capture cycles, the data may be analyzed over the course time for accumulation analysis. For example, events during several consecutive data capture cycles proximate in time may be interpreted as the presence of fissile material when a single event in an isolated data capture cycle may be interpreted as an anomalous radiation. The processor 410 is also able to store integrated data over the course of time and thereby provided an “overall dose” level that indicates the accumulation of all events detected over a given period of time. The ability to use this digital integration technique is enhanced by the binary event detection described above. As a determination is made with the one-bit comparator for each pixel and for each integration period, the processor is able to integrate events rather than accumulated charge. This enhances the ability of the detector because charge may vary from one event to another. Additionally, dark current cannot typically be distinguished from event related charge, and integration of charge would necessarily result in accumulation of the measured dark current, reducing the accuracy of the event count.

The detector 400 of FIG. 4 may further include a low-pass filter 447 that is able to distinguish between relative-slow changes in background radiation by setting a background threshold. That is, because background radiation may be different at different altitudes (sea-level has a lower incidence of radiation than does an elevation of cities such as Denver, for example) or in different local geographies having higher a incidence of natural radioactive materials, the detector is able to adjust itself for the relative change in background radiation. By placing a low-pass filter 447 in the data line, changes in altitude that give rise to a different amount of incident background radiation can be accounted for as well as changes in geographic location.

The detector 400 of FIG. 4 may further include a power supply 420 and an optional power scavenging block 425. The power supply is typically a lithium-ion battery that can be used for long periods of time and is relatively inexpensive and small. In order to increase the life of the power supply, the detector may utilize a number of power scavenging methods. For example, the power scavenging block 425 may be a solar cell that is able to convert light energy into electrical energy. This helps alleviate the rate of power drain on the power supply 420. Other power scavenging devices are contemplated but are not discussed herein for brevity.

Another way that the detector 400 may conserve energy is to employ a sampling mode. In a sampling mode, the detector 400 may only be actively detecting for particular portions of time over a given time period. For example, the processor 410 may be programmed to perform data capture cycles over the first 30 seconds of every minute. In another example, the sampling may be done for one second during a ten-second cycle and then repeated. The sampling may be further controlled by different modes triggered by different events. For example, the detector 400 may be in a “sniffing” mode that actively detects for one second during a ten-second cycle which repeats until an event occurs. When an event is detected, the detector 400 may enter a “wake-up” mode wherein the detector 400 is actively detecting continuously until one minute passes without the detection of an event at which time the detector 400 reverts back to “sniffing” mode. Other sampling methods are contemplated but are not discussed herein for brevity.

In another embodiment, the detector 400 may include a motion sensor or inertia sensor (not shown) that senses when the detector is moved. Upon detection of movement, the detector 400 may enter a sensing mode and upon a predetermined duration of no movement detection, the detector 400 may then revert back to a sleep mode again. Thus, when a detector designed to be a personal safety device is lying dormant on a desk, it will not waste energy detecting when no detecting is needed, but will be active when carried by or attached to a person.

Finally, the detector 400 of FIG. 4 further includes an interface 415 for indicating to a user the occurrence of an event. The interface 415 may be a liquid crystal display, an LED indicator, a simple speaker, or any device capable of indicating an event. In one embodiment, the interface 415 is able to display the relative magnitude and frequency of the event or events. Further, the interface 415 may be able to identify the type of radiation that has been detected as well as the relative intensity of the detected radiation. Indication of processor 410 data is well-known in the art and the interface 415 will not be discussed further herein.

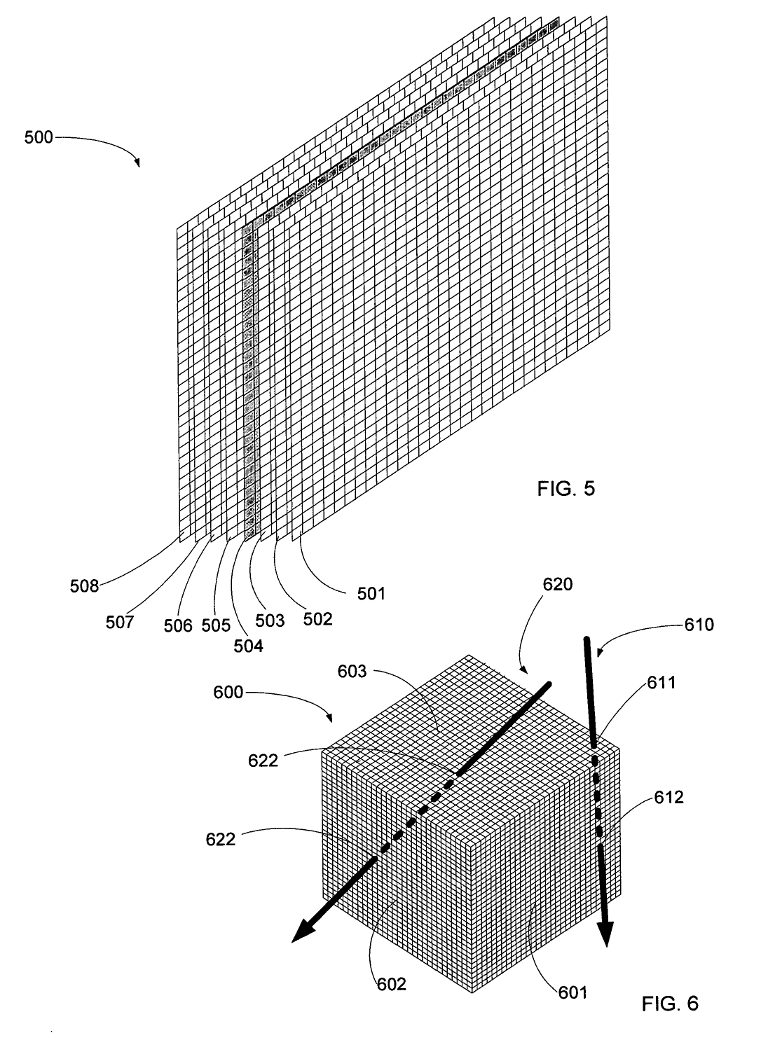

The array of FIG. 4 is typically a Complementary Metal Oxide Semiconductor (CMOS) array of active pixel sensors as described above. The array may also typically be a charge-coupled device (CCD) array of active pixel sensors 405. In some embodiments, the detector 400 may include more than one array 401 for detecting fissile material. Two such embodiments are described in FIGS. 5 and 6.

FIG. 5 is an isometric view of stacked arrays 500 that may be included in the detector of FIG. 4 according to an embodiment of the invention. The stacked arrays 500 include several individual arrays 501-508 that are each positioned one behind the previous. As such, if a particularly high-energy radiation event were to be incident on the stacked arrays 500, the penetration through the stacked arrays 500 can be measured for spectral analysis as a function of mow many arrays in which the radiation is detected. For example, a particularly high-energy radiation event may penetrate to the sixth array 506 indicating a powerful emission. On the other hand, if only the first array 501 detects the radiation, it may be an indication of a low-energy emission. Using such stacked arrays 500, the processor 410 is able to attain even more data about events, thus providing a better basis for radiation detection analysis.

In another embodiment, the different stacked arrays 500 may include additional materials (such as layer 504) between array layers. Such additional material 504 may be more adept at stopping radiation penetration and, thus, aid in stopping the penetrating radiation from reaching through all layers of the stacked array 500. Furthermore, the depth of each layer in the stacked array 500 may be increased or decreased to achieve different penetration detection capabilities.

FIG. 6 is an isometric view of arrays arranged in a cube that may be included in the detector of FIG. 4 according to an embodiment of the invention. The cubed array 600 includes six arrays, three 601-603 of which are visible in the isometric view shown in FIG. 6. With a cubed array 600, the radiation's vector can be determined when the radiation is strong enough to penetrate any two of the six arrays. Because a straight line path of any radiation will necessarily intersect two of the six arrays, a simple calculation at the processor 410 may determine the vector of the radiation, which in turn, provides an indication of the direction of the source of the radiation. For example, radiation traveling on vector 610 will intersect the top array 603 at point 611 and intersect the right array 601 at point 612. As another example, radiation traveling on vector 620 will intersect the top array 603 at point 621 and intersect the left array 602 at point 622. Knowing the vector of the detected radiation is obviously beneficial since the direction from which the radiation came from can indicate the actual source of the radiation, i.e., the location of the fissile material.

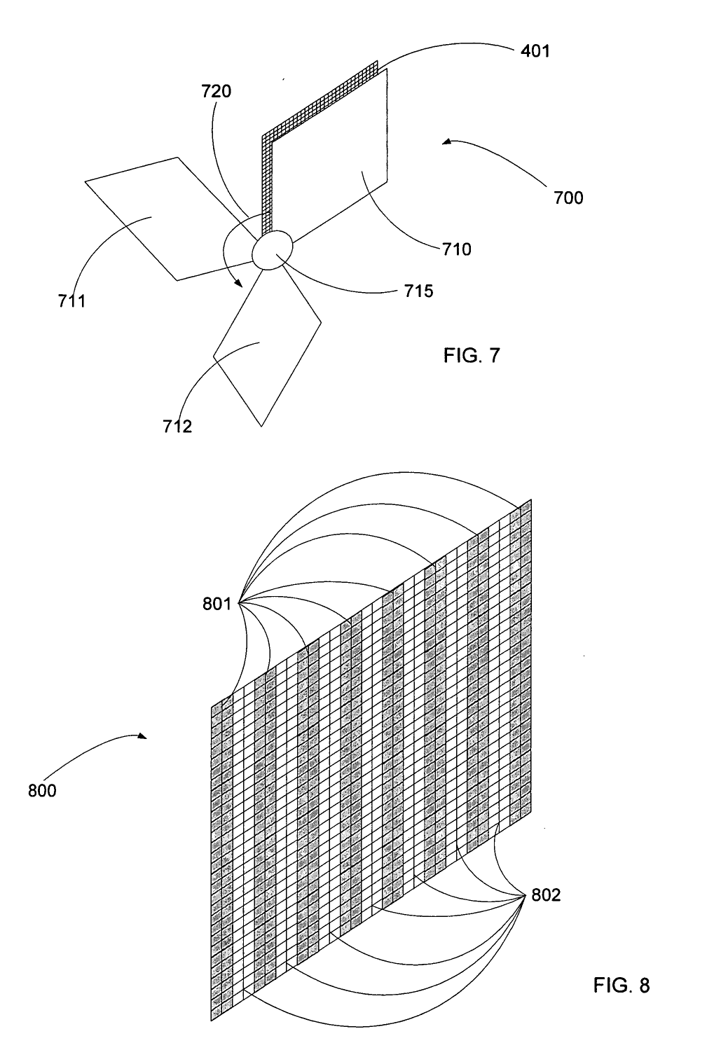

In various embodiments of the present invention, the conversion material of the present invention may be any conversion material capable of producing a charge when radiation is incident upon it. Some conversion materials are better suited than others for producing this reaction. As was discussed above, enriched boron is particularly well suited for producing a reaction when a neutron emitted from fissile material is incident. In another example, lithium is able to produce similar results. Likewise, a gold foil material is able to generate energetic electrons when gamma rays are incident thereupon. Since different conversion materials are better suited than other for detecting particular kinds of emissions, the present invention may include more than one conversion material coatings on the array 401 of FIG. 4. Two such examples of multiple conversion material coatings are described below with respect to FIGS. 7 and 8.

FIG. 7 shows a rotating cover plate mechanism 700 that may be used in conjunction with the array 401 described in FIG. 4 according to an embodiment of the invention. The mechanism 700 includes a plurality of cover plates each having a different conversion material coating disposed thereon. In this embodiment, three such cover plates 710-712 are shown coupled to a central rotating member 715. Each cover plate 710-712 is shaped to fit adjacent to the array 401 when rotated into position. As depicted in FIG. 7, cover plate 710 is positioned adjacent to the array 401. As such, any specific radiation incident upon the cover plate 710 will generate a charge because of the particular conversion material coating (enriched boron, for example) and the charge may then be detected by the active pixel sensors of the array 401.

Such a mechanism 700 is beneficial in that other cover plates 711 and 712 may be coated with a different conversion material (lithium, for example) that is better suited for producing a charge when different types of radiation (gamma radiation, for example) are incident thereupon. In this manner, a particular cover plate 710, 711, or 712 may be rotated into the adjacent position over the array 401 according the characteristics of the particle radiation desired to be detected by simply rotating the central rotating member 715 in the direction 720 until the desired cover plate is in position. Such a mechanism 700 may include several more cover plates that may be moved into position as additional assembly specifications and maneuvering means are contemplated but not described herein for brevity.

FIG. 8 shows an array 800 having coatings of different conversion materials that form a mosaic pattern on the array 800 according to an embodiment of the invention. As was described above, it is beneficial to have different conversion materials (boron and gold, for example) as one may be better suited than another for producing a charge when different types of radiation (neutrons and gamma rays, for example) are incident thereupon. Thus, the array 800 in FIG. 8 includes many different sections 801 of a first conversion material and interlaced between them are many different sections 802 of a second conversion material. Using this array 800, radiation of a first type matched to the first conversion material may be detected in the first set of sections 801. Likewise, radiation of a second type matched to the second conversion material may be detected in the second set of sections 802. In another embodiment, the first section 801 may be an entire left side of the array 800 while the second section 802 may be the entire right side. Such block patterns are easier to manufacture than interlaced patterns. Other mosaic patterns may include more than two sections and may be arranged in different patterns according to other embodiments of the invention but are not described further herein for brevity.

The foregoing features and advantages of a detector 400 according to various embodiments of the invention may be implemented in many different combinations. Not all features described herein are required for a detector to function as a fissile material detector. In fact, a bare minimum of the above-described features may be included within an inexpensive, light-weight, handheld detector.

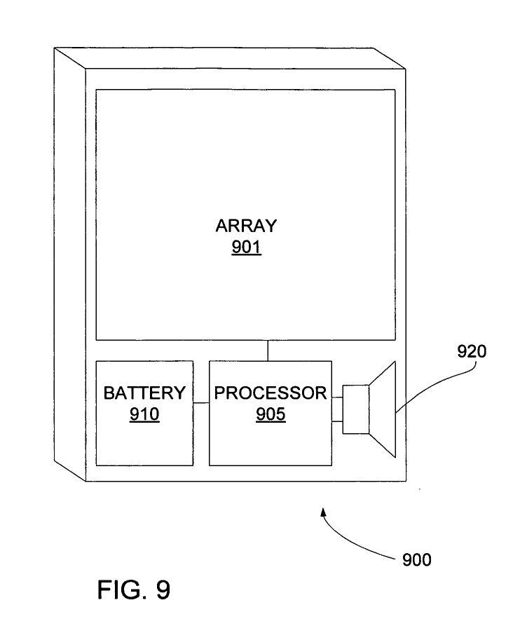

FIG. 9 is a block diagram of a handheld detector 900 having some of the elements of the detector 400 of FIG. 4 according to an embodiment of the invention. The handheld detector 900 is designed to be inexpensive, light-weight, and power efficient. Such a handheld detector 900 is well suited for personal use in many different environments. For example, fissile material detectors at major transportation hubs are designed to be large, highly-accurate, and foolproof in order to prevent false positives and distinguish between many different kinds of radioactive isotopes. Of course, such systems are also expensive, non-portable, and power-hungry.

The handheld detector 900 includes an array 901 that may be any of the arrays described herein capable of detecting fissile material. The array is coupled to a processor 905 that is able to interpret data signals from the array 901. If the processor determines that the array has detected fissile material, the processor may activate an audible alarm 920 or flash an LED (not shown). The entire handheld detector 900 is powered by a small, light-duty, lithium battery 910. The handheld detector 900 may include additional features as were described above with respect to detector 400, but features are added at the expense of complexity, space, and power consumption.

I claim:

1. A detector for detecting fissile material, the detector comprising:
an array of active pixel sensors, each active pixel sensor operable to:
integrate a charge generated by radiation that is incident upon the active pixel sensor by using a charge-sensing element during an integration phase;
generate a voltage signal that is based upon the integrated charge intensity during a readout phase; and
reset the charge-sensing element during a reset phase;
wherein the integration phase is set to a time interval that is optimal for detecting radiation from fissile material; and
a coating disposed adjacent to the array, the coating including a conversion material operable to convert incident radiation into a charge that may be detected by at least one of the active pixel sensors.

2. The detector of claim 1, further comprising a processor coupled to the array, the processor operable to control the duration of the integration phase, the readout phase and the reset phase.

3. The detector of claim 2 wherein the processor is further operable to repeat each cycle according to a predetermined frequency of repetition such that the level of incident radiation is sampled over a predetermined duration of time.

4. The detector of claim 2 wherein the duration of the integration time is controlled to be short enough such that dark current that may accumulate cannot be mistaken for an event, and the duration short enough such that the probability of multiple events occurring in a single pixel in a single integration period is low.

5. The detector of claim 2 wherein the duration of the integration period is controlled to be long enough so as not to waste power with unnecessary readout cycles.

6. The detector of claim 2 wherein the processor is further operable to determine that a plurality of active pixel sensors have detected radiation in a bloom pattern and operable to indicate a single radiation event is incident upon the array based on an analysis of the bloom pattern.

7. The detector of claim 6 wherein the processor is operable to count the number of events and the number of counted events is summed across a number of integration periods.

8. The detector of claim 2, further comprising a 1-bit comparator coupled to the array and operable to indicate the incidence of radiation if the voltage signal generated by a pixel from the detection of the radiation exceeds a predetermined threshold.

9. The detector of claim 2 wherein the coating comprises a first conversion material and a second conversion material disposed in separate contiguous regions.

10. The detector of claim 9 wherein the processor is operable to determine that radiation is incident upon the first conversion material and is operable to determine that radiation is incident upon the second conversion material.

11. The detector of claim 2 wherein the conversion material comprises a first conversion material disposed on a first area of the substrate and a second conversion material disposed on a second area of the substrate, the two areas of the substrate rotatably attached to a maneuvering mechanism operable to maneuver either the first or the second areas of the substrate adjacent to the array.

12. The detector of claim 2, further comprising a low-pass filter coupled between the array and the processor and operable to filer the detection of a relative change in background radiation.

13. The detector of claim 2 wherein the detector further comprises a plurality of additional arrays of active pixel sensors, each additional array disposed adjacent to at least one other array such that radiation may be incident on a first array of active pixel sensors and be detected by charge-sensing elements in subsequent adjacent arrays of active pixel sensors.

14. The detector of claim 2 wherein the detector further comprises a plurality of additional arrays of active pixel sensors, each array arranged to form a cube such that any particle traveling in a straight line though one array of the cube will necessarily travel through a second array of the cube such that vector information about the radiation can be determined.

15. The detector of claim 1 wherein the conversion material comprises enriched boron.

16. A method for detecting fissile material, the method comprising:
detecting the incidence of radiation at an array of active pixel sensors;
determining the quantity of charge generated by the incidence of the radiation at each of the active pixel sensors in which the radiation is incident;
generating a voltage signal proportionate to the intensity determined at each active pixel sensor;
storing data corresponding to the generated voltage signals, the data stored indicative of any bloom pattern that may be associated with the incidence of the radiation; and
designating that only a single radiation event is incident on the array based on indication of the bloom pattern.

17. The method of claim 16, further comprising:
determining the intensity of the charge generated by the incidence of the radiation during a readout phase;
generating a voltage signal proportionate to the determined intensity;
storing data corresponding to the generated voltage signal; and
resetting the sensor during a reset phase.

18. The method of claim 16 wherein the detecting further comprises sampling the sensor according to a predetermined frequency of repetition such that the level of incident radiation is sampled over a predetermined duration of time.

19. The method of claim 16 wherein storing data further comprises analyzing a bloom pattern associated with a cycle of detection to indicate that a single incident radiation event created the bloom pattern.

20. An active pixel sensor array, comprising:
a pattern of active pixel sensors, each active pixel sensor operable to convert charge intensity into an voltage signal; and
a coating disposed adjacent to the pattern, the coating including a first conversion material in a first area operable to react to a first type of radiation and a second conversion material in a second area operable to react to a second type of radiation, the first and second areas being mutually exclusive.

21. The active pixel sensor array of claim 20, further comprising a processor coupled to the array and operable to determine if radiation is incident only in the first area or only in the second area.

22. The active pixel sensor array of claim 20 coupled with a plurality of additional arrays, each disposed adjacently below one another and each having an additional pattern such that radiation incident upon the first pattern in the normal will necessarily be incident upon each of the plurality of additional arrays and coupled with a processor such that each of the plurality of arrays and operable to determine how many of the plurality of arrays detect radiation incident on the arrays such that a spectral analysis of the radiation is determined.

23. The active pixel sensor array of claim 20 coupled with five additional equal size arrays, each array disposed such that a cube is formed by the six arrays wherein radiation incident upon any one array will necessarily be incident upon at least one other array, each array coupled to a processor operable to determine a vector associated with radiation incident on two arrays.

24. A detector for detecting fissile material, the detector comprising:
an active pixel sensor array, including:
a pattern of active pixel sensors, each active pixel sensor operable to convert charge intensity into an voltage signal; and
a coating disposed adjacent to the pattern, the coating including a conversion material operable to react to radiation that is incident upon the coating;
a processor coupled to the active pixel sensor array and operable to receive the voltage signal;
a battery coupled to the processor and operable to provide electrical power to the processor and the active pixel sensor array; and
an alarm coupled to the processor and operable to activate when the processor receives the electrical signal.

25. The detector of claim 24 wherein the active pixel sensor array is coupled with a plurality of additional arrays, each disposed adjacently below one another and each having an additional pattern such that radiation incident upon the first pattern in the normal will necessarily be incident upon each of the plurality of additional arrays and coupled with a processor such that each of the plurality of arrays and operable to determine how many of the plurality of arrays detect radiation incident on the arrays such that a spectral analysis of the radiation is determined.

26. The detector of claim 24 wherein the active pixel sensor array is coupled with five additional equal size arrays, each array disposed such that a cube is formed by the six arrays wherein radiation incident upon any one array will necessarily be incident upon at least one other array, each array coupled to a processor operable to determine a vector associated with radiation incident on two arrays.
